(19) United States
(12) Patent Application Publication
(10) Pub. No.: US 2004/0250648 A1
(43) Pub. Date: Dec. 16, 2004

(54) Method of using compression springs to create a desired torsional load

(75) Inventor: Amit Chaugule, Ithaca, NY (US)

Correspondence Address: BORGWARNER INC., POWERTRAIN TECHNICAL CENTER, 3800 AUTOMATION AVENUE, SUITE 100, AUBURN HILLS, MI, 48326-1782, US

(73) Assignee: BorgWarner Inc., Auburn Hills, MI

(21) Appl. No.: 10/462,330

(22) Filed: Jun. 16, 2003

(51) Int. Cl. F16F 15/10

(52) U.S. Cl. 74/574

(57) ABSTRACT

A method of introducing torsional load into a phaser, having the steps of determining the required torsional load between the rotor and housing needed to generate the desired performance in the phaser, choosing the number of springs to introduce the required torsional load based on space and design requirements of the torque generating device, and determining the spring characteristics required for the desired performance of the phaser. The springs are circumferentially placed in the end plate fixed to the housing having spaced block projections, and a spring retention plate fixed to the rotor having apertures for receiving the spaced block projections. One end of the springs are placed adjacent to tabs located on a back side of the spring retention plate and the other end of the springs are placed adjacent to the block projections of the end plate, such that motion between the rotor and housing introduces torsional load.

### BACKGROUND OF THE INVENTION

1. Field of the Invention

The invention pertains to the field of variable valve timing. More particularly, the invention pertains to a method of producing torsional stiffness between two rotating parts.

2. Description of Related Art

In some internal combustion engines, torsional dampers have been used to reduce and absorb the vibrations of a rotating shaft preventing the transfer of the shaft vibrations to other areas of the engine system by using combinations of friction plates and torsion springs. For example U.S. Pat. No. 1,518,360 uses an annular plate and washers compressed between the inner member and the spring loaded annular member whereby oscillation is damped out and all end slack is eliminated.

Another example of a damper is shown in U.S. Pat. No. 1,165,529 in which parts of a spring sprocket wheel are provided with radial arms or projections that extend beyond the circle of the sprocket teeth and have a spring connection between the outer portion of the projecting portion beyond the sprocket teeth.

Another example is U.S. Pat. No. 6,161,512, which uses a sprocket with three circumferentially spaced stops and a hub including three spaced hub locators. Springs are attached between adjacent hub locators and rotational stops. Friction plates are also included and provide damping action, such that the sprocket only rotates slightly relative to the hub locator. The internal torsional damper of this patent is biased in two directions and the spring is not controlled. Other examples include U.S. Pat. Nos. 447,447, 306,267, and 1,254,542.

The present invention provides a method of controlling the torque exerted by a mechanism containing springs. The present invention decreases the size of prior art torque producing mechanisms both axially and radially. The present invention is also easier to assemble and divides the load on the spring equally between the number of springs present increasing the life of the torque producing mechanism.

### SUMMARY OF THE INVENTION

A method of introducing torsional load into a phaser, having the steps of determining the required torsional load between the rotor and housing needed to generate the desired performance in the phaser, choosing the number of springs to introduce the required torsional load based on space and design requirements of the torque generating device, and determining the spring characteristics required for the desired performance of the phaser. The springs are circumferentially placed in the end plate fixed to the housing having spaced block projections, and a spring retention plate fixed to the rotor having apertures for receiving the spaced block projections. One end of the springs are placed adjacent to tabs located on a back side of the spring retention plate and the other end of the springs are placed adjacent to the block projections of the end plate, such that motion between the rotor and housing introduces torsional load.

### BRIEF DESCRIPTION OF THE DRAWING

FIG. 1 shows an isometric view of the end plate.

FIG. 2a shows a top view of the end plate.

FIG. 2b shows a sectional view of the end plate along line D-D in FIG. 2a.

FIG. 3 shows an isometric view of the front of the spring retention plate of the torque producing mechanism.

FIG. 4 shows an isometric view of the back of the spring retention plate of the torque producing mechanism.

FIG. 5a shows a front view of the front of the spring retention plate.

FIG. 5b shows a sectional view of the spring retention plate along line A-A in FIG. 5a.

FIG. 6 shows a front view of the back of the spring retention plate.

FIG. 7 shows an isometric view of tabs in the torque producing mechanism.

FIG. 8 shows an expanded view of the torque producing mechanism.

### DETAILED DESCRIPTION OF THE INVENTION

In a variable cam timing (VCT) system, the timing gear or sprocket on the camshaft is replaced by a variable angle coupling known as a “phaser”, having a rotor connected to the camshaft and a housing connected to (or forming) the timing gear, which allows the camshaft to rotate independently of the timing gear, within angular limits, to change the relative timing of the camshaft and crankshaft. The term “phaser”, as used here, includes the housing and the rotor, and all of the parts to control the relative angular position of the housing and rotor, to allow the timing of the camshaft to be offset from the crankshaft. In the multiple-camshaft engine, it will be understood that there could be one phaser on each camshaft, as is known to the art.

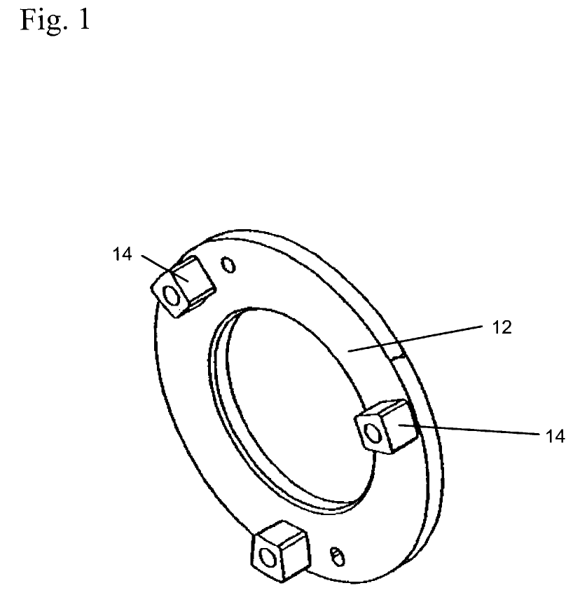

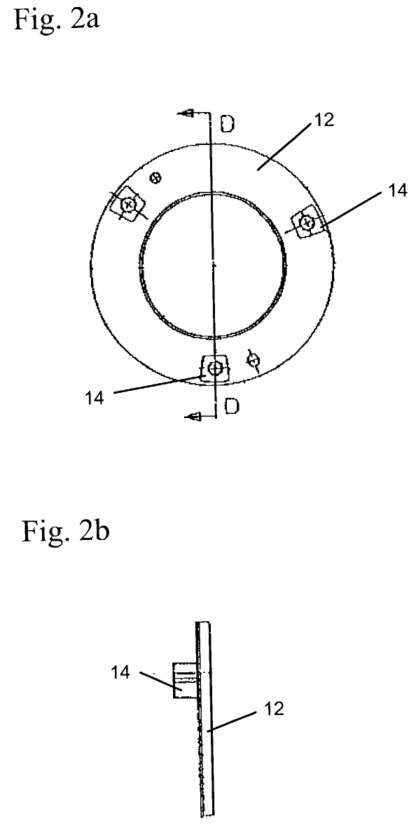

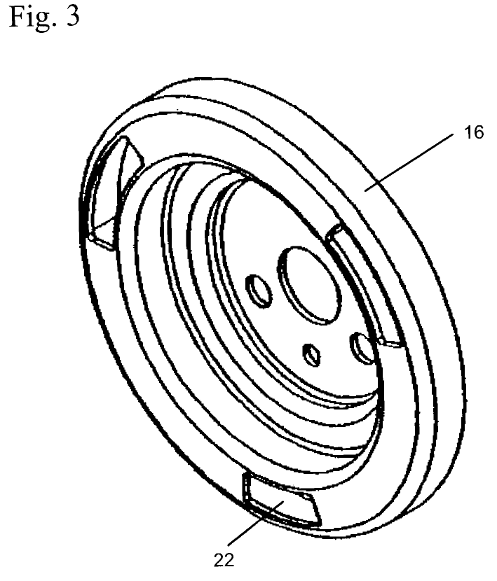

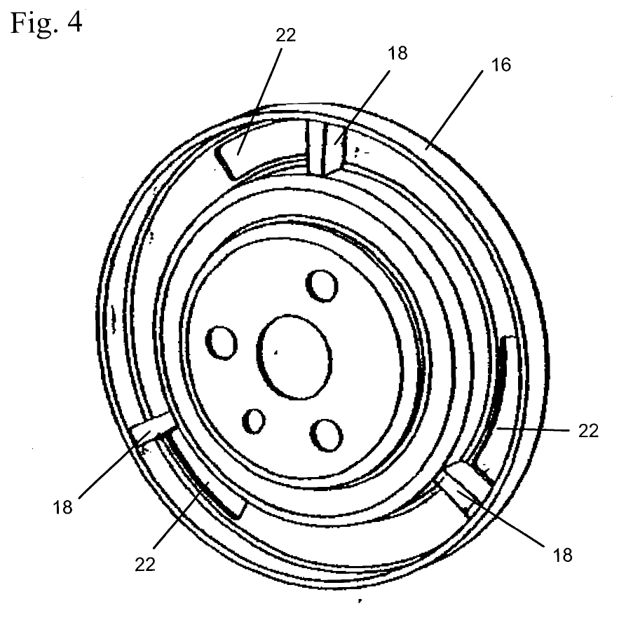

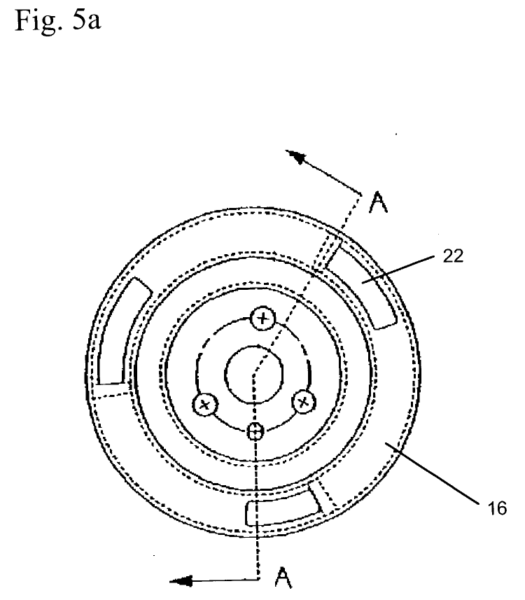

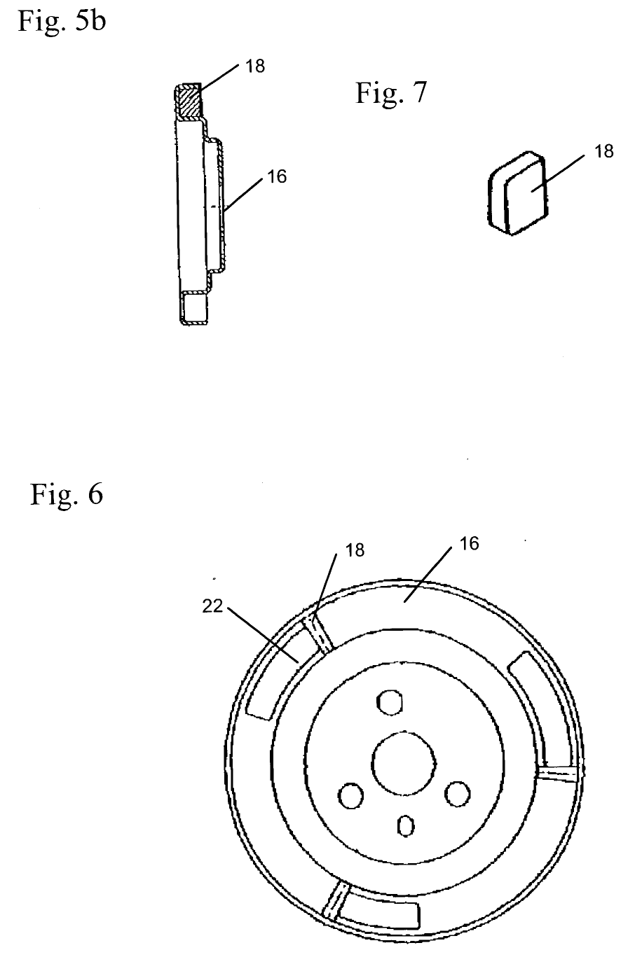

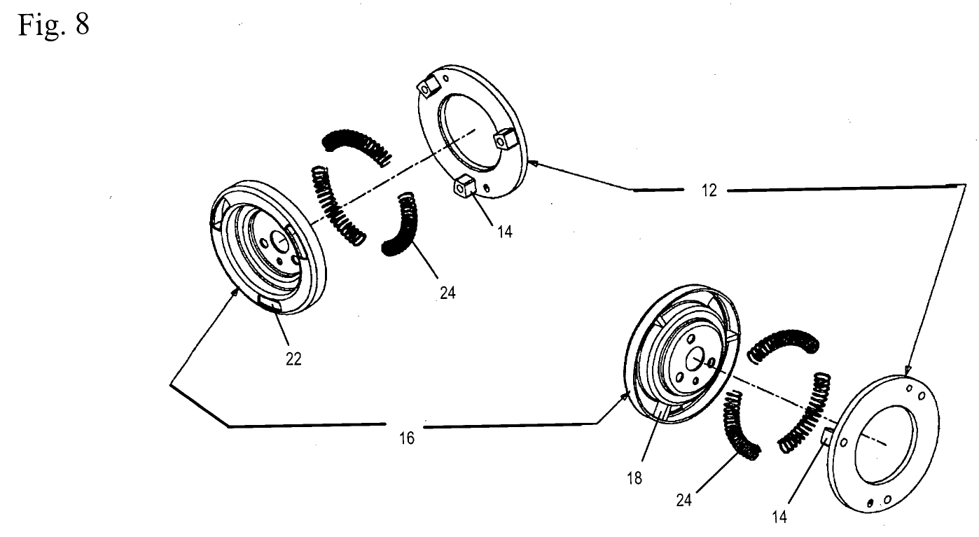

In phasers, a torsional load is commonly needed to help actuate the system or to offset an accessory torque, such as an oil pump, vacuum pump, or other such device, to bring the phaser back to base timing. The torsional load or stiffness is between the two rotating parts of the phaser, the rotor and the housing (not shown). A spring retention plate 16 fixed to the rotor and an end plate 12 fixed to the housing are mountably attached to each other. Between the spring retention plate 16 and the end plate 12 are circumferentially placed compression springs 24. In FIG. 8 three springs are shown, but depending upon the size restrictions more or less springs may be used in keeping with the spirit of the invention. One end of the spring 24 is placed adjacent to tabs 18, (shown in FIGS. 4, 5b, and 7) located on the back side of the spring retention plate 16 and the other end of the spring 24 is placed adjacent to the block projections 14 (shown in FIGS. 1, 2a, and 2b) located on the end plate 12. By placing one end of the springs 24 to one of the rotating parts of the phaser, the rotor or the housing and the other end of the spring 24 to second rotating part of the phaser, the other rotor or housing, the springs are easily preloaded. The block projections 14 are spaced such on the end plate that they are received by the apertures 22 in the spring retention plate 16. Bolt are then used to fasten the spring retention plate 16 to the end plate 12 securely. The secure fastening of the spring retention plate 16 to the end plate 12 also prevents bucking of the springs 24.

The movement of either the end plate 12 or the spring retention plate 16 results in a torsional load between the spring retention plate 16 and the end plate 12, such that the device acts as a torsional damper to one side only.

A method of generating the required torsional load using the above described device requires certain steps. The first step is to determine the required torsional load in order to achieve the desired performance of the phaser by simulation. Based on the required torsional load and the space available, the number of springs to be used are chosen. Then, spring characteristics are determined. Examples of spring characteristics include, but are not limited to: spring rate, number of turns the spring contains, outer diameter of the spring, and wire pitch of the spring. The spring characteristics are chosen to allow the springs to compress to a specific length allowing the torque generated to be specifically controlled. For example, if due to space availability three springs were chosen to be placed circumferentially between the two rotating parts of the phaser and if the amount of torque that is needed to generate the desired performance of the phaser by simulation was 4 Nm. The spring's outer diameter and wire pitch are chosen such that the torque needed, 4 Nm, is easily achieved. In this instance the three springs placed circumferentially would have an outer diameter of 10 mm and a wire pitch of 80.02 mm. From the chosen springs outer diameter and wire pitch, the deflection at both pre-load conditions and maximum load conditions can easily be determined. In this example, the deflection of the springs at pre-load conditions is 29 Nm and 45 Nm at maximum load conditions. The deflection of the springs at pre-load conditions corresponds to 1.2 Nm torque for each spring and 1.8 Nm torque at maximum load conditions. Since the springs act in parallel, sharing the load equally among the springs present, the total torque exerted by the three springs is 3.6 Nm at pre-load conditions and 5.4 Nm at maximum load conditions, meeting the necessary torque requirement for the desired performance of the phaser.

By controlling the spring characteristics in the torque producing device, the force and therefore the torque generated by the springs may easily be controlled, while decreasing the size of the device both axially and radially, making the device easy to assemble and increasing the life of the torque producing mechanism.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A method of introducing torsional load into a phaser comprising a rotor and a housing, comprising the steps of:
a) determining required torsional load between the rotor and the housing needed to generate desired performance in the phaser;
b) choosing a number of springs to introduce the required torsional load based on space and design requirements of a torque generating device;
c) determining spring characteristics required for a response to result in the desired performance of the phaser;
d) placing the springs from step b) circumferentially in a torque generating device comprising:
i) an end plate fixed to a housing having spaced block projections, and
ii) a spring retention plate fixed to a rotor having apertures for receiving the spaced block projections of the end plate,
wherein a first end of the springs from step d) are placed adjacent to tabs located on a back side of the spring retention plate and a second end of the springs are placed adjacent to the block projections of the end plate, such that any relative motion between the rotor and the housing introduces torsional load into the phaser.

2. The method of claim 1, wherein the springs are compression springs.

3. The method of claim 1, wherein the spring characteristics are spring rate, spring location, the number of turns of the spring, and the outer diameter of the spring.
